(19) United States
(12) Patent Application Publication
(10) Pub. No.: US 2026/0257598 A1
(43) Pub. Date: Sep. 3, 2026

(54) SHOCK ABSORBING SEAT PEDESTAL

(71) Applicant: Raptor Performance Shocks, Warroad, MN (US)

(72) Inventor: Jake R. Anderson, Warroad, MN (US)

(73) Assignee: Raptor Performance Shocks, Warroad, MN (US)

(21) Appl. No.: 19/067,446

(22) Filed: Feb. 28, 2025

(51) Int. Cl. B60N 2/50; B60N 2/54

(52) U.S. Cl. CPC B60N 2/505; B60N 2/54

(57) ABSTRACT

A shock absorbing seat pedestal is provided that includes a shock and a spring. The spring is positioned around a shaft and a body of the shock. A seat plate is configured to mount a seat to the shock absorbing seat pedestal. The shock includes the shaft, a piston and the body. The shaft has an upper shaft portion and a lower shaft portion. The lower shaft portion and the piston are received within the body. The lower spring portion of the spring is rotationally fixed to the body. The body is coupled to a base mount. An upper spring portion of the spring is rotationally fixed to a spring pinch retainer. A release handle is configured to manipulate the spring pinch retainer to selectively prevent a rotation of the shaft of the shock relative to the spring.

### BACKGROUND

To mitigate the effects of rapid up and down movement experienced by passengers when vehicles travel across rough surfaces, shock absorbing systems may be employed. Generally, shock absorbing systems work by converting kinetic energy into heat which is dissipated into the atmosphere. A common way to dissipate the heat is through hydraulic fluid. In vehicles with wheels, a suspension system that is coupled to the wheels typically provides the shock absorbing functions. Other types of vehicles that do not use wheels, such as a boat, may incorporate a shock absorbing feature in a seat pedestal.

Further, it may be desired to provide a seat that rotates in certain situations. For example, in a boat application, it may be desirable to allow the seat to rotate when the boat is not being propelled forward or backward. However, it may also be desired or required that the seat be locked in a static position when the boat is being propelled forward or backwards for safety reasons.

For the reasons stated above and for other reasons stated below which will become apparent to those skilled in the art upon reading and understanding the present specification, there is a need in the art for an effective and efficient seat pedestal with a shock absorbing function for a vehicle that allows for a selective rotation of a seat coupled to the seat pedestal.

### SUMMARY

The following summary is made by way of example and not by way of limitation. It is merely provided to aid the reader in understanding some of the aspects of the subject matter described. Embodiments provide a shock absorbing seat pedestal that allows for a seat coupled to the pedestal to be selectively rotatable.

In one embodiment, a shock absorbing seat pedestal is provided. The shock absorbing seat pedestal includes a seat plate, a shock, a spring, a base mount, a spring pinch retainer and a release handle. The seat plate is configured to mount a seat to the shock absorbing seat pedestal. The shock includes a shaft, a piston and a body. The shaft has an upper shaft portion and a lower shaft portion. The piston is engaged with the lower shaft portion. The lower shaft portion and the piston are received within the body. The spring is positioned around a portion of the shaft and a portion of the body of the shock. The lower spring portion of the spring is rotationally fixed to the body. The base mount is configured to be mounted to a floor of a vehicle. The body is coupled to the base mount. An upper spring portion of the spring is rotationally fixed to the spring pinch retainer. The release handle is configured to manipulate the spring pinch retainer to selectively prevent a rotation of the shaft of the shock relative to the spring.

In another embodiment, another shock absorbing seat pedestal is provided. The shock absorbing seat pedestal includes a seat plate, a shock, a spring, a base mount, a spring pinch retainer, an upper shaft mount, and a release handle. The seat plate is configured to mount a seat to the shock absorbing seat pedestal. The shock includes a shaft, a piston and a body. The shaft has an upper shaft portion and a lower shaft portion. The piston is engaged with the lower shaft portion of the shaft. The lower shaft portion and the piston are received within the body. The spring is positioned around a portion of the shaft and a portion of the body of the shock. A lower spring portion of the spring is rotationally fixed to the body. The base mount is configured to be mounted to a floor of a vehicle. The body coupled to the base mount. The spring pinch retainer positioned around the upper shaft portion of the shaft of the shock. The spring pinch retainer is rotationally fixed to an upper spring end of the spring. The upper shaft mount is coupled to the seat plate and the upper shaft portion of the shaft. The upper shaft mount further received within a retainer central passage of the spring pinch retainer. A portion of the upper shaft portion of the shaft of the shock received within a central recess of the upper shaft mount. The release handle is configured to selectively manipulate the spring pinch retainer to clamp down on the upper shaft mount to prevent a rotation of the shaft of the shock relative to the spring.

In yet another embodiment, a method of forming a shock absorbing seat pedestal that selectively rotates is provided. The method includes coupling one of a spring pinch retainer and an upper shaft portion of a shaft to a seat plate in a static connection; locking an upper spring portion of a spring that is positioned around the shock to the spring pinch retainer in a fashion to prevent rotation between the upper spring portion of the spring and the spring pinch retainer; locking a lower portion of the spring to prevent rotation of the lower portion of the spring in relation to a base mount configured to be coupled to a floor of a vehicle; and engaging the spring pinch retainer with a release handle, the release handle configured to manipulate the spring pinch retainer to selectively do one of prevent the seat plate from rotating in relation to the spring and allow the seat plate to rotate in relation to the spring.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a shock absorbing seat pedestal according to an example aspect of the present invention;

FIG. 2 is an unassembled side perspective view of the shock absorbing seat pedestal of FIG. 1;

FIG. 3 is an unassembled partial view of the shock absorbing seat pedestal of FIG. 1;

FIG. 4 is an unassembled side perspective view of the shock absorbing seat pedestal of FIG. 1;

FIG. 5 is a side perspective view of the shock absorbing seat pedestal of FIG. 1;

FIG. 6 is a side perspective cross-sectional view of the shock absorbing seat pedestal of FIG. 1;

FIG. 7 illustrates a side perspective partial unassembled view of a shock absorbing seat pedal according to another example aspect of the present invention;

FIG. 8 illustrates a side perspective view of the shock absorbing seat pedestal of FIG. 7;

FIG. 9 illustrates a side view of the shock absorbing seat pedestal of FIG. 7; and

FIG. 10 illustrates a shock absorbing seat pedestal formation flow diagram according to one example aspect of the present application.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a shock absorbing seat pedestal. The shock absorbing seat pedestal includes a selectable seat rotation function. The shock absorbing seat pedestal may be used in vehicle applications where the vehicle is subject to rapid up and down movement. One example application for the shock absorbing seat pedestal of the present invention is for a watercraft vehicle. Other applications are contemplated. Embodiments use a spring over a shock arrangement. In examples, a spring arrangement prevents rotation of a seat coupled to the shock absorbing seat pedestal when the shock absorbing seat pedestal is in a locked configuration. Further in one embodiment, the height of the shock absorbing seat pedestal is adjustable.

The terms “coupled to” along with derivations of the terms, may be used herein. These terms indicate that two or more elements are interacting with each other. The interaction includes the physical connecting of the two or more elements. The interaction between the two or more elements may be direct or through intermediate elements. Further, the terms “locked” and “rotationally fixed” along with derivations of the terms may be used herein. These terms describe a relationship between at least two elements that prevents rotation “in relation to” or “relative to” each other.

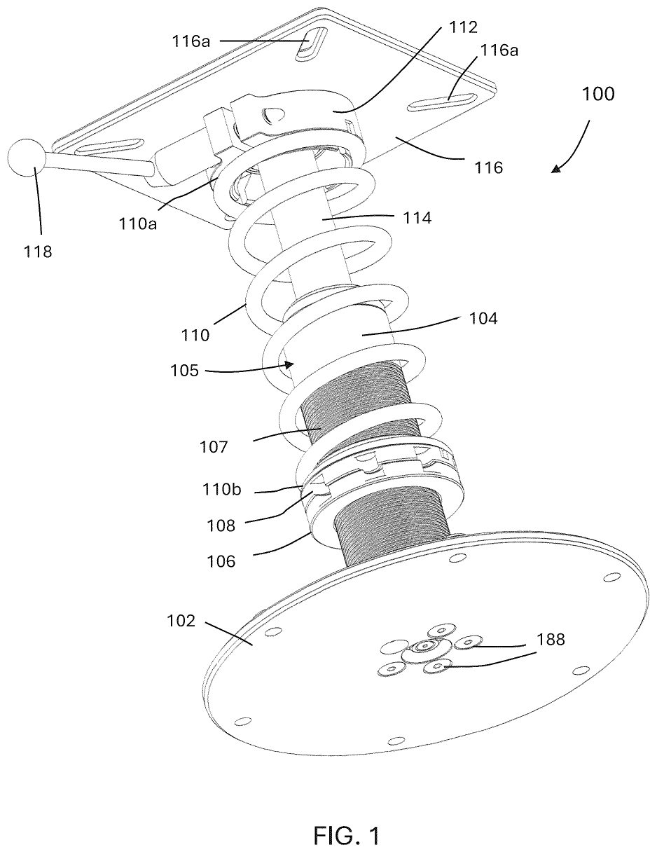

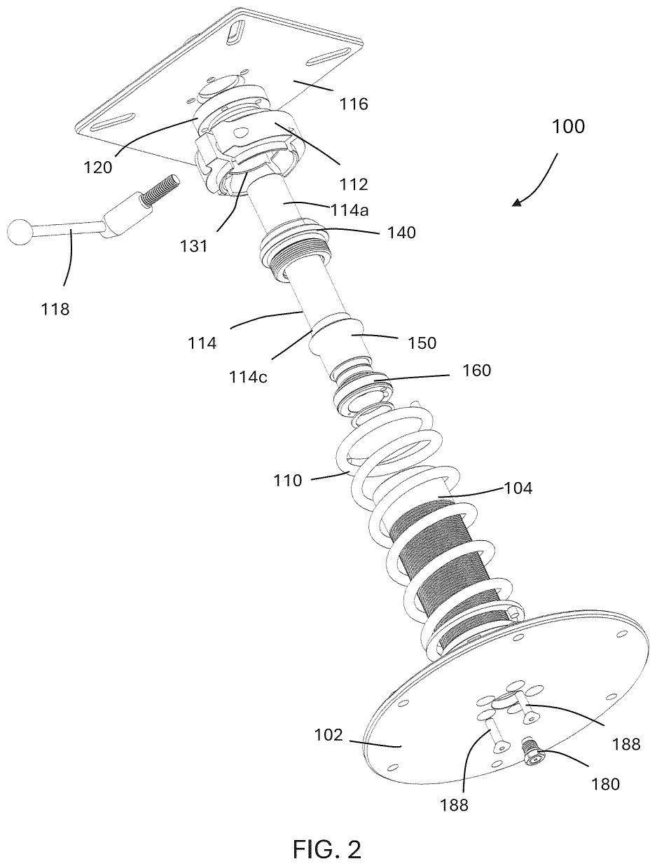

FIG. 1 illustrates a side perspective view of an example of a shock absorbing seat pedestal 100 of the present invention. FIG. 2 illustrates an unassembled side view of the shock absorbing seat pedestal 100. In view of FIGS. 1 and 2, the shock absorbing seat pedestal 100 includes a base mount 102 that is configured to be mounted to a surface of a vehicle, such as a floor of a vehicle. A shock 105, that includes a body 104 and a shaft 114, extends from the base mount 102 in a perpendicular fashion. In the example of shock absorbing seat pedestal 100 of FIG. 2, the body 104 is coupled to the base mount 102 via fasteners 188. Body 104 includes external threads 107 in which a spring jam retaining nut 106 is threadably engaged. Also threadably engaged with the external threads 107 of body 104 is a spring adjuster 108. A lower spring end 110e of a spring 110 is engaged with the spring adjuster 108. An upper spring end 110c of the spring 110 is engaged with a spring pinch retainer 112.

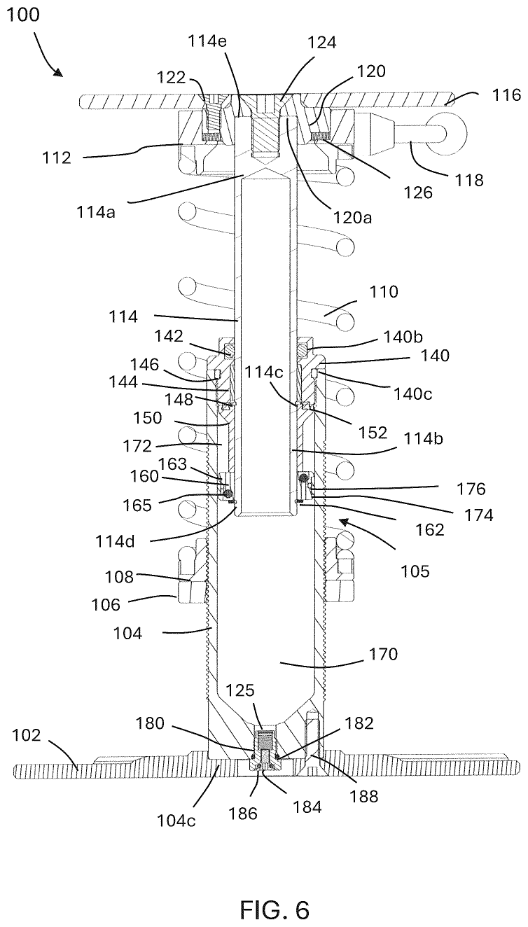

A lower shaft portion 114b of the shaft 114 of shock 105 is received within the body 104. An upper shaft portion 114a of the shaft 114 is received within a retainer central passage 131 of the spring pinch retainer 112 as best illustrated in the cross-sectional side view of FIG. 6. A release handle 118 is engaged with the spring pinch retainer 112. The release handle 118 (or adjusting handle) is configured to selectively cause the spring pinch retainer 112 to change diameter to clamp down on the upper shaft portion 114a of shaft 114 to selectively prevent and allow rotation of shaft 114 in relation to the spring pinch retainer 112. In the example shown, the release handle 118 clamps down on an upper shaft mount 120, that is received within the spring pinch retainer 112, when clamping down on the upper shaft portion 114a of the shaft to prevent the rotation described above. Seat plate 116 is configured to be coupled to a seat (not shown) through seat apertures 116a as illustrated in FIG. 1.

As discussed above, in this example, the shock absorbing seat pedestal 100, further includes the upper shaft mount 120. The upper shaft mount 120 includes a central recess 120a that is configured to receive a portion of the upper shaft portion 114a of the shaft 114. Upper shaft mount 120 is coupled to the seat plate 116 via screw fasteners 122. An upper shaft end 114e of the shaft 114 is to the upper shaft mount 120 via fastener 124. Accordingly, in this example both the shaft 114 and the upper shaft mount 120 are rotational fixed to the seat plate 116. This is best illustrated in FIG. 6. A washer 126 is positioned between the upper shaft mount 120 and the spring pinch retainer 112 in this example.

In embodiments, spring 110 is used to prevent rotation of a seat attached to the seat plate 116 when the shock absorbing seat pedestal 100 is in a locked configuration. In examples, spring 110 is configured to prevent rotation of the spring pinch retainer 112. In the locked configuration, the spring pinch retainer 112 is locked onto the upper shaft end 114e of the shaft 114 via the spring pinch retainer 112 clamping down on the upper shaft mount 120. In an unlocked configuration, the upper shaft mount 120 and shaft 114 may rotate inside the spring pinch retainer 112, as discussed further below, which allows the seat plate 116 (and a seat coupled to the seat plate 116) and the shaft 114 of the shock 105 to rotate relative to (in relation to) the spring pinch retainer 112 and spring 110.

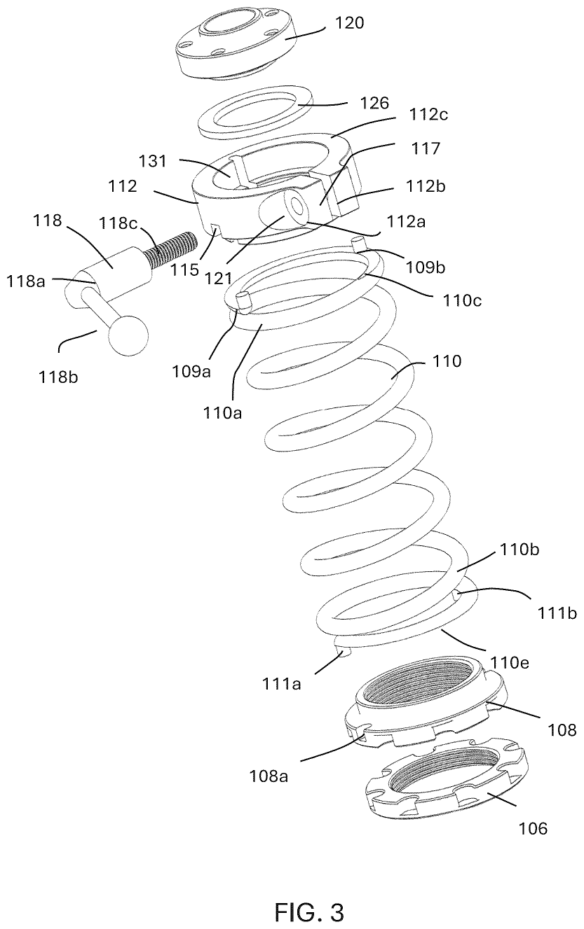

FIG. 3 illustrates an unassembled view of a portion of shock absorbing seat pedestal 100. In view of FIG. 3, the spring pinch retainer 112 includes a first connecting flange 112a and a second connecting flange 112b that both extend radially from a ring shaped body portion 112c of the spring pinch retainer 112. The spring pinch retainer 112 includes a gap 117 that is positioned between the first connecting flange 112a and the second connecting flange 112b.

Release handle 118 includes a cylindrical shaped base portion 118a. An external threaded engaging portion 118c extends from the base portion 118a. A manipulation portion 118b extends in a perpendicular fashion from the base portion 118a. The threaded engaging portion 118c is received within a passage 121 in the first connecting flange 112a, the threaded engaging portion 118c of the release handle further is received in a threaded passage (not shown) in the second connecting flange 112b. Rotation of the release handle 118 causes the external threads on the threaded engaging portion 118c to move in relation to the threads in the threaded passage of the second connecting flange 112b to selectively change the gap 117 between the first connecting flange 112a and the second connection flange 112b of the spring pinch retainer 112. This selectively clamps down on the upper shaft mount 120. When release handle 118 is moved via the manipulation portion 118b to cause the spring pinch retainer 112 to clamp down on the upper shaft mount 120, shaft 114 cannot rotate because spring 110, which is rotationally fixed to the spring pinch retainer 112, prevents rotation as discussed below. However, when release handle 118 is rotated so spring pinch retainer 112 does not clamp down on the upper shaft mount 120, shaft 114 is allowed to rotate, which allows the seat plate 116 and a seat (not shown) to rotate.

Spring 110, in this example, includes two spaced top holding knobs 109a and 109b that extend axially from a top spring end 110c of the spring 110. Each top holding knob 109a and 109b is received within an associated holding slot 115 in a lower spring pinch retainer portion of the spring pinch retainer 112. This arrangement prevents rotation of the spring pinch retainer 112 in relation to spring 110. Spring 110 further includes two spaced lower holding knobs 111a and 111b that extend axially from a lower spring end 110e of the spring 110. Each lower holding knob 111a and 111b is received within an associated holding slot 108a in the spring adjuster 108. A jam retaining nut 106 threadably engaging with the external threads 107 of body 104 is positioned to engage the spring adjuster 108. This configuration prevents the lower spring portion 110b of the spring 110 from rotating in relation to the body 104 of shock 105.

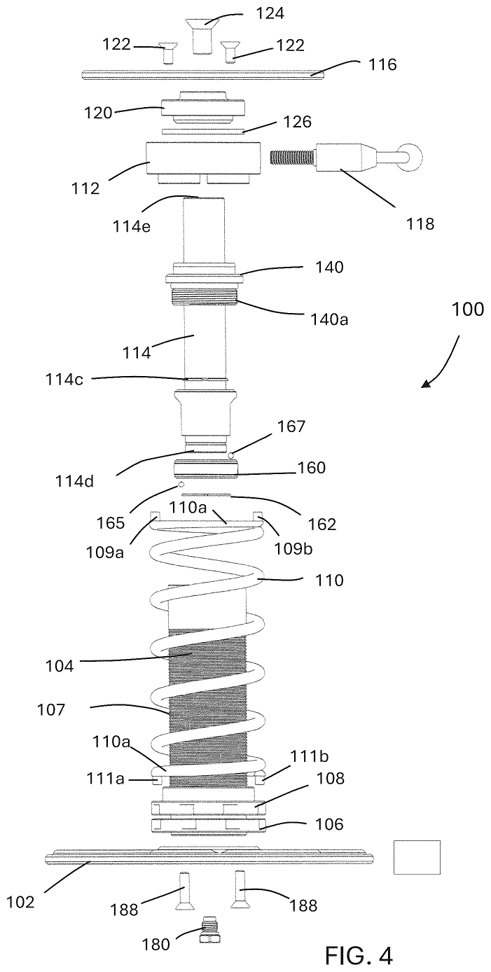

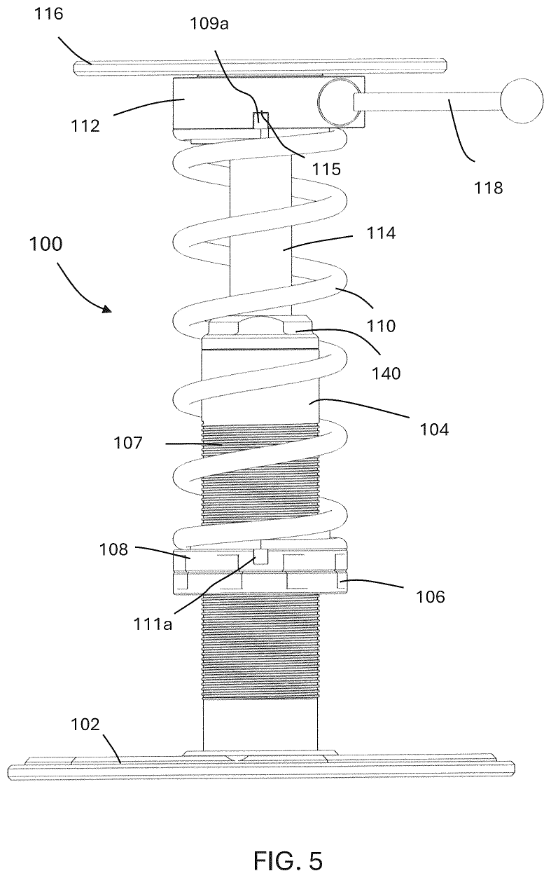

As illustrated in FIG. 2, FIG. 4, FIG. 5 and FIG. 6, the shock absorbing seat pedestal 100 further includes a body cap 140 that provides an interface between the shaft 114 and the body 104 of shock 105. The body cap 140 in this example includes external threads 140a that engage internal threads within the body 104. A first seal 142, which is an O-ring in this example, is positioned within a seal groove 140b within an interior surface of the body cap 140. Seal 142 is positioned to provide a seal between the body cap 140 and shaft 114. A bearing 144, which is a plain bearing in this example, is positioned between an inside surface of the body cap 140 and an outer surface of the shaft 114. A retaining ring 148 is positioned within a first retaining groove 114c of shaft 114 to retain the bearing 144 at a desired location. In one example, retaining ring 148 is a spear head retaining ring. A second seal 146, which is an O-ring in this example, is positioned between proximate an outer shoulder 140c of the body cap 140 and an end of the body 104.

An internal spacer bumper 150 is mounted around the shaft 114. A third seal 152 is positioned between an end of the body cap 140 and an end of the internal spacer bumper 150 as best illustrated in FIG. 6. In one example, the third seal 152 is an X shaped ring. A piston 160 is mounted around the lower shaft portion 114b of the shaft 114. A second retaining ring 162 is received within a second groove 114d of the shaft 114. The piston 160 is held in place on the shaft 114 by a second retaining ring 162 and an end of the internal spacer bumper 150 in this example. The piston 160 includes fluid passages 163 that include check balls 165 and 167 that selectively pass fluid between fluid passages 170 and 172 to control movement of the piston 160 within the body 104. A band 174 is received in a groove on an outside surface of the piston 160. The band 174 of the piston 160 engages an interior wall of the body 104 as the piston 160 and shaft 114 moves within the body 104 to dampen movement experienced by the shock absorbing seat pedestal 100. A fourth seal 176 is positioned between the band 174 and the body of the piston 160.

The lower end of the body 104 of the shock absorbing seat pedestal 100 includes a threaded fill passage 125. A fill port plug 180 with external threads threadably engages the threaded fill passage 125. A fifth seal 182 is positioned between the lower base end 104c and a head portion of the threaded fill port plug 180. Fill port plug 180 in this example, includes a threaded plug central passage. A fill screw 184 is selectively threadably engaged with the threaded plug central passage of fill port plug 180. A sixth seal 186 is position between a head of the fill screw 184 and a surface of the fill port plug 180 to prevent fluid leakage when the fill screw 184 is snuggly tightened down on the fill port plug 180. In one example, both the fifth seal 182 and the sixth seal 186 are O-ring seals. The lower base end 104c is attached to the base mount 102 via fasteners 188.

In the example of the shock absorbing seat pedestal 100 described above, a seat coupled to the seat plate 116 is not allowed to rotate when the shock absorbing seat pedestal 100 is in a locked configuration. In the locked configuration, the release handle 118 is tightened causing the spring pinch retainer 112 to clamp down on the upper shaft mount 120. Since the spring pinch retainer 112 cannot rotate relative to the spring 110, shaft 114 cannot rotate. Since the seat plate 116 is coupled to the shaft 114, neither the seat plate 116 nor a seat coupled to the seat plate 116 can rotate in the locked configuration.

If the operator wants the seat to swivel, or rotate, the operator grasps the manipulation portion 118b of the release handle 118 and rotates the release handle 118 to release the pressure that causes the spring pinch retainer 112 to clamp down on the upper shaft mount 120. Once the shaft 114 of the shock 105 is free to rotate, the shock absorbing seat pedestal 100 is in a seat rotating configuration where the seat plate 116 (and a seat coupled to the seat plate 116) is free to rotate. To place the shock absorbing seat pedestal 100 back into the lock configuration, the operator simply has to rotate the manipulation portion 118b of the release handle 118 to cause the spring pinch retainer 112 to once again clamp down on the upper shaft mount 120.

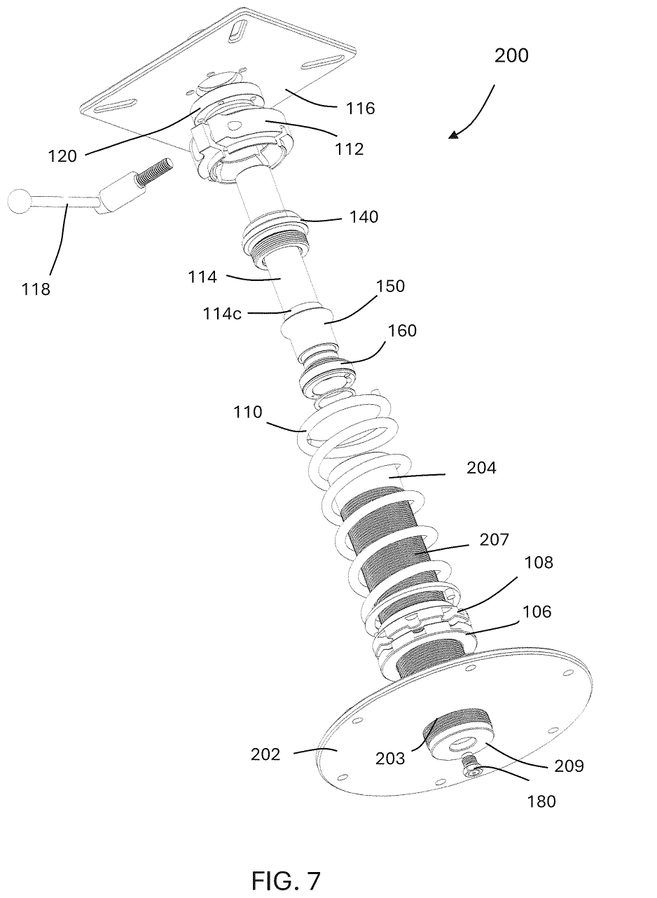

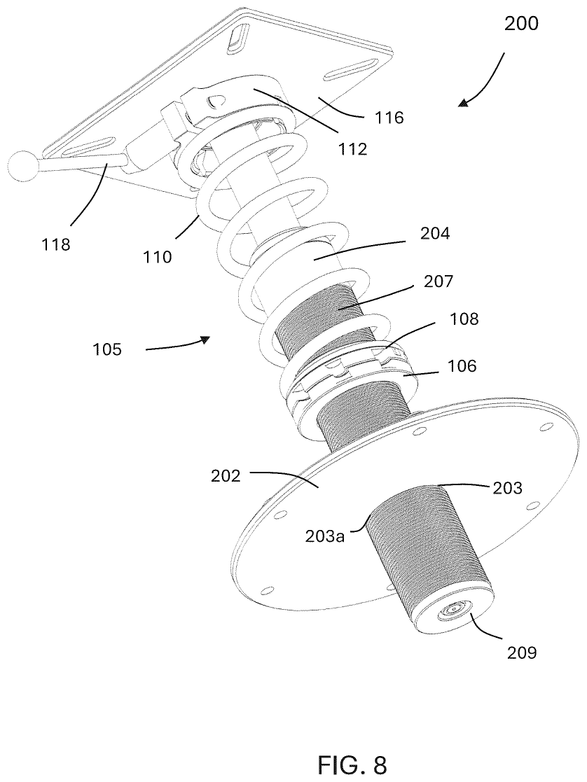

FIG. 7 illustrates a side perspective partial unassembled view of a shock absorbing seat pedestal 200 of another example. FIG. 8 illustrates a side perspective view of the assembled shock absorbing seat pedestal 200. In this example, the body 204 includes external threads 107 that extend down the shaft 114 proximately to an end 209 of the body 204. Further, in this example, the base mount 202 includes a base mount central passage 203 with internal threads 203a. The external threads 207 of the body 204 engage the internal threads 203a of the base mount central passage 203 of the base mount 202. This allows for an adjustment of the height of the shock absorbing seat pedestal 200 in relation to a floor of a vehicle. The height may be adjusted by simply rotating the body 204 of the shock absorbing seat pedestal 200 in relation to the base mount 202. As discussed above, the base mount 202 is configured to be coupled to the floor, or outer surface, of the vehicle. In one example, vehicles such as boats, typically include a space between the floor and hull or other structures to allow for a portion of the body 204 that includes the external threads 207 to recess under the floor to change the height of the shock absorbing seat pedestal 200 in relation to the floor of the vehicle. This allows for the use of just one shock absorbing seat pedestal that can be adjusted in height instead of having to purchase multiple different shock absorbing seat pedestals of different heights.

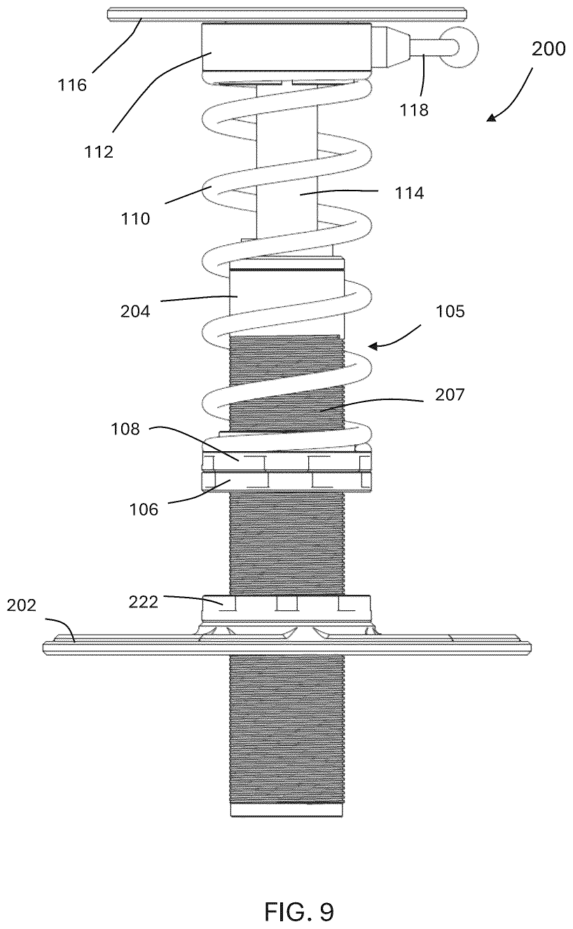

As best illustrated in the side view of the shock absorbing seat pedestal 200 in FIG. 9, a jam nut 222 with internal threads that engage the external threads 207 of the body 204, is selectively positioned to engage the base mount 202 to selectively lock rotation of the body 204 of the shock 105 to the base mount 202. This configuration allows for the adjustment of the height of the shock absorbing seat pedestal 200 by rotating the shock absorbing seat pedestal 200 to position the body 204 either farther down into the base mount 202 or up out of the base mount 202. Once the select height of the shock absorbing pedestal 200 is achieved, the jam nut 222 is tightened down on the base mount 202 to prevent the body 204 of the shock absorbing seat pedestal 200 from rotating in relation to the base mount 202 (which would be statically coupled to a floor of the vehicle).

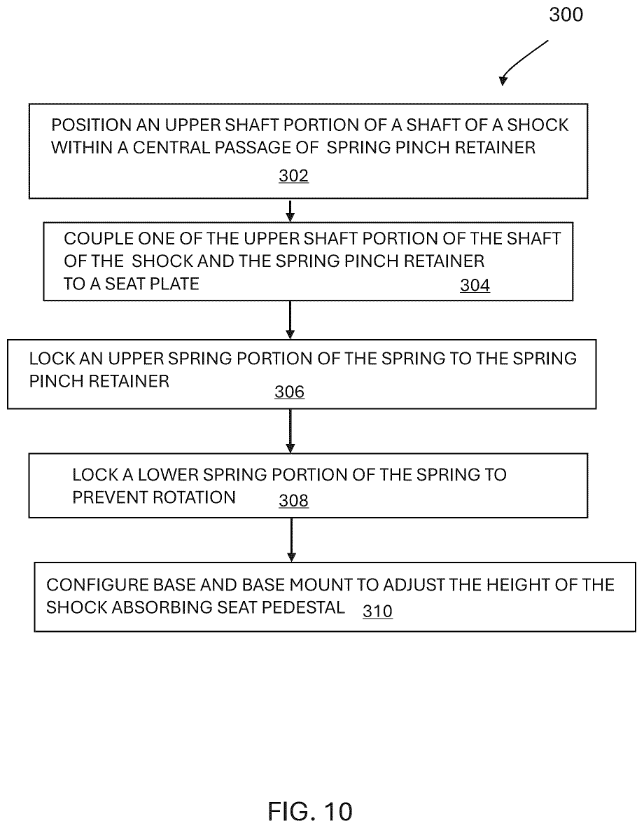

A method of forming a shock absorbing seat pedestal that selectively rotates is illustrated in a shock absorbing seat pedestal formation flow diagram 300 of FIG. 10. The shock absorbing seat pedestal formation flow diagram 300 includes a series of sequential blocks. The blocks may occur in another order or even in parallel in other embodiments. Hence, the present invention is not limited to the sequence of the block set out in the shock absorbing seat pedestal formation flow diagram 300.

The shock absorbing seat pedestal formation flow diagram 300 starts at block 302 where the shaft 114 of shock 105 is positioned within a retainer central passage 131 of the spring pinch retainer 112. In an example, an upper shaft mount 120 is positioned between the upper shaft portion 114a and the spring pinch retainer 112. The upper shaft portion 114a of the shaft 114 is received within the central recess 120a of the upper shaft mount 120 in this example.

At block 304, either the upper shaft portion 114a of the shaft or the spring pinch retainer 112 is coupled to the seat plate 116. In the embodiments discussed above, the upper shaft portion 114a is coupled to the seat plate 116 and the spring pinch retainer 112 selectively clamps down to prevent rotation of the seat plate 116. However, in another example, the spring pinch retainer 112 may be coupled to the seat plate 116. In this example, unclamping down (loosening) of the spring pinch retainer 112 allows the seat plate 116 to rotate. In the example with the upper shaft portion 114a of the shaft 114 coupled to the seat plate 116, an upper shaft mount 120 may be used as discussed above. The upper shaft mount 120 and the upper shaft portion 114a are both coupled to the seat plate 116 to rotationally fix (rotationally lock) the upper shaft portion 114a of shaft 114 to seat plate 116. As described above, the release handle 118 is configured to manipulate the spring pinch retainer 112 to clamp down on the upper shaft mount 120 to selectively prevent the rotation of the shaft 114 of the shock 105 relative to the spring 110.

An upper spring portion 110a of the spring 110 is locked to the spring pinch retainer 112 at block 306. The upper spring portion 110a of spring 110 is positioned around shock 105 and is locked to spring pinch retainer 112 in a fashion to prevent rotation between the upper spring portion 110a of the spring 110 and the spring pinch retainer 112. In one example, the locking (or coupling) of the upper spring portion 110a of the spring 110 to the spring pinch retainer 112 is done with at least one upper holding knob 109a, that extends from the upper spring end 110c of the spring 110, being positioned in at least one holding slot 115 of the spring pinch retainer 112. This arrangement locks or rotationally fixes the upper spring portion 110a of the spring 110 to the spring pinch retainer 112.

At block 308, a lower spring portion 110b of the spring 110 is locked to prevent rotation of the lower spring portion 110b of the spring 110 in relation to the base mount 102 that is configured to be coupled to a floor of a vehicle. In one example this is done by coupling the lower spring portion 110b of the spring 110 to the body 104 of the shock 105 in a fashion to prevent rotation between the lower spring portion 110b of the spring 110 and the body 104 of the shock 105. Further, in an example the locking of the lower spring portion 110b of the spring 110 to the body 104 of the shock 105 further includes coupling the spring adjuster 108 to the body 104 of the shock 105 and then locking the spring adjuster 108 in a static location on the shock 105. In one example, a spring jam retaining nut 106 that engages external threads 107 on the body is used to lock the spring adjuster 108 in the static location on the shock 105. Further, in an example, at least one lower holding knob 111a of the spring 110 is positioned in at least one holding slot 108a of the spring adjuster 108. This arrangement locks or rotationally fixes the lower spring portion 110b of the spring 110 to the body 104 of the shock 105 and hence to the base mount 102.

In one example, the body 104 of the shock 105 and the base mount 102 are configured to adjust the height of the shock absorbing seat pedestal 100 in block 310. In an example, the body 204 includes external threads 207 that extends to a lower end of body 204. The external threads 207 are configured to engage internal threads in a central passage in the base mount 202. The adjustment of the body 204 of the shock 105 in relation to the base mount 202 via the threaded connection adjusts the height of the shock absorbing seat pedestal 100. Preventing the unintended rotation of the body 204 of the shock 105 may be accomplished with a jam nut 222 as discussed above.

### EXAMPLE EMBODIMENTS

Example 1 includes a shock absorbing seat pedestal. The shock absorbing seat pedestal includes a seat plate, a shock, a spring, a base mount, a spring pinch retainer and a release handle. The seat plate is configured to mount a seat to the shock absorbing seat pedestal. The shock includes a shaft, a piston and a body. The shaft has an upper shaft portion and a lower shaft portion. The piston is engaged with the lower shaft portion. The lower shaft portion and the piston are received within the body. The spring is positioned around a portion of the shaft and a portion of the body of the shock. The lower spring portion of the spring is rotationally fixed to the body. The base mount is configured to be mounted to a floor of a vehicle. The body is coupled to the base mount. An upper spring portion of the spring is rotationally fixed to the spring pinch retainer. The release handle is configured to manipulate the spring pinch retainer to selectively prevent a rotation of the shaft of the shock relative to the spring.

Example 2 includes the shock absorbing seat pedestal of Example 1, further including an upper shaft mount that is coupled to the upper shaft end of the shaft. The upper shaft portion of the shaft is received within a central recess of the upper shaft mount. The release handle configured to manipulate the spring pinch retainer to clamp down on the upper shaft mount to prevent the rotation of the shaft of the shock relative to the spring.

Example 3 includes the shock absorbing seat pedestal of any of the Examples 1-2, wherein the body includes external threads.

Example 4 includes the shock absorbing seat pedestal of any of the Examples 1-3, wherein the base mount includes a base mount central passage with internal threads. The internal threads of the base mount configured to threadably engage the external threads of the body to couple the body to the base mount and allow for an adjustment of height of the shock absorbing seat pedestal in relation to the floor.

Example 5 includes the shock absorbing seat pedestal of Examples 3, further including a spring adjustment ring with internal threads that are configured to threadably engage the external threads of the body. The spring adjustment ring is further configured to statically engage the lower spring portion to rotationally fix the lower spring portion of the spring to the body.

Example 6 includes the shock absorbing seat pedestal of Example 5, wherein the spring adjustment ring includes at least one holding slot configured to receive at least one lower holding knob of the spring to rotationally fix the lower spring portion of the spring to the body.

Example 7 includes the shock absorbing seat pedestal of Example 5, further including a spring jam retaining nut with internal threads that are configured to threadably engage the external threads of the body and engage the spring adjustment ring to selectively lock the spring engagement ring at a desired location on the body.

Example 8 includes the shock absorbing seat pedestal of any of the Examples 1-7, wherein the spring pinch retainer further includes at least one holding slot that is configured to receive at least one upper holding knob that extends from an upper spring end of the spring to rotationally fix the upper spring portion of the spring to the spring pinch retainer.

Example 9 includes the shock absorbing seat pedestal of any of the Examples 1-8, wherein the spring pinch retainer further includes a first connection flange and a second connection flange. The spring pinch retainer has a gap that is positioned between the first connection flange and the second connection flange.

Example 10 includes the shock absorbing seat pedestal of Example 9, wherein the release handle further includes a base portion, a manipulation portion and a threaded engaging portion. The manipulation portion is coupled proximate a first end of the base portion. The threaded engaging portion extends from a second end of the base portion. The threaded engaging portion is configured to engage at least one set of internal threads within at least one passage in each of the first connection flange and the second connection flange to selectively change a diameter of the spring pinch retainer to selectively clamp down to prevent the rotation of the shaft of the shock relative to the spring.

Example 11 includes a shock absorbing seat pedestal. The shock absorbing seat pedestal includes a seat plate, a shock, a spring, a base mount, a spring pinch retainer, an upper shaft mount, and a release handle. The seat plate is configured to mount a seat to the shock absorbing seat pedestal. The shock includes a shaft, a piston and a body. The shaft has an upper shaft portion and a lower shaft portion. The piston is engaged with the lower shaft portion of the shaft. The lower shaft portion and the piston are received within the body. The spring is positioned around a portion of the shaft and a portion of the body of the shock. A lower spring portion of the spring is rotationally fixed to the body. The base mount is configured to be mounted to a floor of a vehicle. The body coupled to the base mount. The spring pinch retainer positioned around the upper shaft portion of the shaft of the shock. The spring pinch retainer is rotationally fixed to an upper spring end of the spring. The upper shaft mount is coupled to the seat plate and the upper shaft portion of the shaft. The upper shaft mount further received within a retainer central passage of the spring pinch retainer. A portion of the upper shaft portion of the shaft of the shock received within a central recess of the upper shaft mount. The release handle is configured to selectively manipulate the spring pinch retainer to clamp down on the upper shaft mount to prevent a rotation of the shaft of the shock relative to the spring.

Example 12 includes the shock absorbing seat pedestal of Examples 11, wherein the base mount includes a base mount central passage with internal threads. The internal threads of the base mount are configured to threadably engage external threads of the body to couple the body to the base mount and allow for an adjustment of height of the shock absorbing seat pedestal in relation to the floor of the vehicle.

Example 13 includes the shock absorbing seat pedestal of Examples 12, further including a base mount jam retaining nut with internal threads that is configured to threadably engage the external threads of the body and engage the base mount to lock a selected height of the shock absorbing pedestal in relation to the floor of the vehicle.

Example 14 includes the shock absorbing seat pedestal of any of the Examples 11-13, further including a spring adjustment ring and spring jam retaining nut. The spring adjustment ring has internal threads that are configured to threadably engage external threads of the body. The spring adjustment ring is further configured to statically engage the lower spring portion to rotationally fix the lower spring portion of the spring to the body. The spring jam retaining nut includes internal threads that are configured to threadably engage the external threads of the body and engage the spring adjustment ring to selectively lock the spring engagement ring at a desired location on the body.

Example 15 includes the shock absorbing seat pedestal of any of the Examples 11-14, wherein the release handle further includes a base portion, a manipulation portion, and threaded engaging portion. The manipulation portion is coupled proximate a first end of the base portion. The threaded engaging portion extends from a second end of the base portion. The threaded engaging portion is configured to engage at least one set of internal threads within at least one passage in each of a first connection flange and a second connection flange of the spring pinch retainer to selectively change a diameter of the spring pinch retainer to selectively clamp down to prevent the rotation of the shaft of the shock relative to the spring.

Example 16 includes a method of forming a shock absorbing seat pedestal that selectively rotates. The method includes coupling one of a spring pinch retainer and an upper shaft portion of a shaft to a seat plate in a static connection; locking an upper spring portion of a spring that is positioned around the shock to the spring pinch retainer in a fashion to prevent rotation between the upper spring portion of the spring and the spring pinch retainer; locking a lower portion of the spring to prevent rotation of the lower portion of the spring in relation to a base mount configured to be coupled to a floor of a vehicle; and engaging the spring pinch retainer with a release handle, the release handle configured to manipulate the spring pinch retainer to selectively do one of prevent the seat plate from rotating in relation to the spring and allow the seat plate to rotate in relation to the spring.

Example 17 includes the method of Example 16, further wherein locking the upper spring portion of the spring that is positioned around the shock to the spring pinch retainer further includes positioning at least one upper holding knob that extends from an upper spring end of the spring in at least one holding slot of the spring pinch retainer to rotationally fix the upper spring portion of the spring to the spring pinch retainer.

Example 18 includes the method of any of the Examples 16-17, further including locking the lower spring portion of the spring to a body of the shock in a fashion to prevent rotation between the lower spring portion of the spring and the body of the shock.

Example 19 includes the method of any of the Examples 16-18, further wherein locking the lower spring portion of the spring to the body of the shock further includes coupling a spring adjuster to the body of the shock; locking the spring adjuster in a static location on the shock; and positioning at least one lower holding knob of the spring in at least one holding slot of the spring adjuster.

Example 20 includes the method of any of the Examples 1-19, further including adjustably coupling a body of the shock to the base mount to allow for an adjustment in height of the shock absorbing seat pedestal.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A shock absorbing seat pedestal comprising:
a seat plate configured to mount a seat to the shock absorbing seat pedestal;
a shock including,
a shaft having an upper shaft portion and a lower shaft portion,
a piston engaged with the lower shaft portion, and
a body, the lower shaft portion and the piston received within the body;
a spring positioned around a portion of the shaft and a portion of the body of the shock, a lower spring portion of the spring rotationally fixed to the body;
a base mount configured to be mounted to a floor of a vehicle, the body coupled to the base mount;
a spring pinch retainer, an upper spring portion of the spring rotationally fixed to the spring pinch retainer; and
a release handle configured to manipulate the spring pinch retainer to selectively prevent a rotation of the shaft of the shock relative to the spring.

2. The shock absorbing seat pedestal of claim 1, further comprising:
an upper shaft mount coupled to an upper shaft end of the shaft, the upper shaft portion of the shaft received within a central recess of the upper shaft mount, the release handle configured to manipulate the spring pinch retainer to clamp down on the upper shaft mount to prevent the rotation of the shaft of the shock relative to the spring.

3. The shock absorbing seat pedestal of claim 1, wherein the body includes external threads.

4. The shock absorbing seat pedestal of claim 3, wherein the base mount includes a base mount central passage with internal threads, the internal threads of the base mount configured to threadably engage the external threads of the body to couple the body to the base mount and allow for an adjustment of height of the shock absorbing seat pedestal in relation to the floor.

5. The shock absorbing seat pedestal of claim 3, further comprising:
a spring adjustment ring including internal threads configured to threadably engage the external threads of the body, the spring adjustment ring further configured to statically engage the lower spring portion to rotationally fix the lower spring portion of the spring to the body.

6. The shock absorbing seat pedestal of claim 5, wherein the spring adjustment ring includes at least one holding slot configured to receive at least one lower holding knob of the spring to rotationally fix the lower spring portion of the spring to the body.

7. The shock absorbing seat pedestal of claim 5, further comprising:
a spring jam retaining nut including internal threads configured to threadably engage the external threads of the body and engage the spring adjustment ring to selectively lock the spring engagement ring at a desired location on the body.

8. The shock absorbing seat pedestal of claim 1, wherein the spring pinch retainer further comprises:
at least one holding slot configured to receive at least one upper holding knob that extends from an upper spring end of the spring to rotationally fix the upper spring portion of the spring to the spring pinch retainer.

9. The shock absorbing seat pedestal of claim 1, wherein the spring pinch retainer further comprises:
a first connection flange; and
a second connection flange, the spring pinch retainer having a gap that is positioned between the first connection flange and the second connection flange.

10. The shock absorbing seat pedestal of claim 9, wherein the release handle further comprises:
a base portion;
a manipulation portion coupled proximate a first end of the base portion; and
a threaded engaging portion extending from a second end of the base portion, the threaded engaging portion configured to engage at least one set of internal threads within at least one passage in each of the first connection flange and the second connection flange to selectively change a diameter of the spring pinch retainer to selectively clamp down to prevent the rotation of the shaft of the shock relative to the spring.

11. A shock absorbing seat pedestal comprising:
a seat plate configured to mount a seat to the shock absorbing seat pedestal;
a shock including,
a shaft having an upper shaft portion and a lower shaft portion,
a piston engaged with the lower shaft portion of the shaft, and
a body, the lower shaft portion and the piston received within the body;
a spring positioned around a portion of the shaft and a portion of the body of the shock, a lower spring portion of the spring rotationally fixed to the body;
a base mount configured to be mounted to a floor of a vehicle, the body coupled to the base mount;
a spring pinch retainer positioned around the upper shaft portion of the shaft of the shock, the spring pinch retainer rotationally fixed to an upper spring end of the spring;
an upper shaft mount coupled to the seat plate and the upper shaft portion of the shaft, the upper shaft mount further received within a retainer central passage of the spring pinch retainer, a portion of the upper shaft portion of the shaft of the shock received within a central recess of the upper shaft mount; and
a release handle configured to selectively manipulate the spring pinch retainer to clamp down on the upper shaft mount to prevent a rotation of the shaft of the shock relative to the spring.

12. The shock absorbing seat pedestal of claim 11, wherein the base mount includes a base mount central passage with internal threads, the internal threads of the base mount configured to threadably engage external threads of the body to couple the body to the base mount and allow for an adjustment of height of the shock absorbing seat pedestal in relation to the floor of the vehicle.

13. The shock absorbing seat pedestal of claim 12, further comprising:
a base mount jam retaining nut including internal threads configured to threadably engage the external threads of the body and engage the base mount to lock a selected height of the shock absorbing pedestal in relation to the floor of the vehicle.

14. The shock absorbing seat pedestal of claim 11, further comprising:
a spring adjustment ring including internal threads configured to threadably engage external threads of the body, the spring adjustment ring further configured to statically engage the lower spring portion to rotationally fix the lower spring portion of the spring to the body; and
a spring jam retaining nut including internal threads configured to threadably engage the external threads of the body and engage the spring adjustment ring to selectively lock the spring engagement ring at a desired location on the body.

15. The shock absorbing seat pedestal of claim 11, wherein the release handle further comprises:
a base portion;
a manipulation portion coupled proximate a first end of the base portion; and
a threaded engaging portion extending from a second end of the base portion, the threaded engaging portion configured to engage at least one set of internal threads within at least one passage in each of a first connection flange and a second connection flange of the spring pinch retainer to selectively change a diameter of the spring pinch retainer to selectively clamp down to prevent the rotation of the shaft of the shock relative to the spring.

16. A method of forming a shock absorbing seat pedestal that selectively rotates, the method comprising:
coupling one of a spring pinch retainer and an upper shaft portion of a shaft to a seat plate in a static connection;
locking an upper spring portion of a spring that is positioned around the shock to the spring pinch retainer in a fashion to prevent rotation between the upper spring portion of the spring and the spring pinch retainer;
locking a lower spring portion of the spring to prevent rotation of the lower portion of the spring in relation to a base mount configured to be coupled to a floor of a vehicle; and
engaging the spring pinch retainer with a release handle, the release handle configured to manipulate the spring pinch retainer to selectively do one of prevent the seat plate from rotating in relation to the spring and allow the seat plate to rotate in relation to the spring.

17. The method of claim 16, further wherein locking the upper spring portion of the spring that is positioned around the shock to the spring pinch retainer further comprising:
positioning at least one upper holding knob that extends from an upper spring end of the spring in at least one holding slot of the spring pinch retainer to rotationally fix the upper spring portion of the spring to the spring pinch retainer.

18. The method of claim 16, further comprising:
locking the lower spring portion of the spring to a body of the shock in a fashion to prevent rotation between the lower portion of the spring and the body of the shock.

19. The method of claim 18, further wherein locking the lower spring portion of the spring to the body of the shock further comprising:
coupling a spring adjuster to the body of the shock;
locking the spring adjuster in a static location on the shock; and
positioning at least one lower holding knob of the spring in at least one holding slot of the spring adjuster.

20. The method of claim 16 further comprising:
adjustably coupling a body of the shock to the base mount to allow for an adjustment in height of the shock absorbing seat pedestal.
